(19) United States
(12) Patent Application Publication
(10) Pub. No.: US 2004/0206917 A1
(43) Pub. Date: Oct. 21, 2004

(54) System and method for detecting radioactive contamination

(76) Inventor: Christopher John Rourk, Dallas, TX (US)

Correspondence Address: Chris Rourk, P.O. Box 701355, Dallas, TX, 75370, US

(21) Appl. No.: 10/840,683

(22) Filed: May 6, 2004

Related U.S. Application Data
(63) Continuation-in-part of application No. 10/356,956, filed on Feb. 3, 2003, now Pat. No. 6,750,458.
(60) Provisional application No. 60/420,388, filed on Oct. 22, 2002.

(51) Int. Cl. G01T 1/00

(52) U.S. Cl. 250/474.1

(57) ABSTRACT

A method for detecting radioactive contamination is provided. The method includes placing a radiochromic material on a surface. It is then determined whether spotting of the radiochromic material has occurred. If spotting of the radiochromic material has occurred, it is determined that radioactive contamination has been detected.

### RELATED APPLICATIONS

This application is a continuation-in-part to pending application Ser. No. 10/356,956, filed Feb. 2, 2003, through which it claims priority to U.S. provisional application No. 60/420,388, filed Oct. 22, 2003, both of which are expressly incorporated by reference for all purposes.

### FIELD OF THE INVENTION

The present invention pertains to the field of radiation detection, and more particularly to a system and method for detecting radioactive contamination that uses radiochromic materials.

### BACKGROUND

Radiation dosimetery usually involves systems and processes that determine accurate dose exposures to alpha, beta, and gamma radiation. Such dosimeters include personal dosimeters that are used to determine dose exposures in the range of several hundred roentgen-equivalent man (REM). Levels of exposure over several hundred REM for a whole body dose can be fatal, so dosimeters measuring in excess of several hundred REM are not usually considered suitable for use in personal dosimetry. While such high-dose dosimeters can be less expensive, more expensive low-dose dosimeters that cost over $100 each are typically used.

Radiochromic film materials are known in the art that change color when exposed to radiation. These radiochromic film materials are calibrated so as to be able to easily perform dosimetry. The calibration procedure substantially increases the cost of producing the radiochromic film materials, as it is necessary to statistically verify that all of the radiochromic film material meets the calibration criteria by testing samples of the radiochromic film material.

### SUMMARY OF THE INVENTION

In accordance with the present invention, a system and method for are provided for detecting radioactive contamination that overcome known problems with detecting radioactive contamination.

In particular, a system and method for detecting radioactive contamination are provided that use radiochromic materials that can be easily surveyed with the unaided human eye to determine whether radioactive contamination is present. In addition, the use of uncalibrated radiochromic materials greatly reduces the manufacturing cost, while having little or no effect on the ability to use the radiochromic materials to detect contamination.

In accordance with an exemplary embodiment of the present invention, a method for detecting radioactive contamination is provided. The method includes placing an uncalibrated radiochromic material on a surface. It is then determined whether spotting of the radiochromic material has occurred. If spotting of the radiochromic material has occurred, it is determined that radioactive contamination has been detected.

The present invention provides many important technical advantages. One important technical advantage of the present invention is a system and method for detecting radioactive contamination that can detect low dose rate contamination using dosimetry equipment that is very inexpensive and easy to operate. The present invention uses radiochromic dosimeters or other dosimeters that are generally unsuitable for detecting low doses to detect particulate radioactive material that has been deposited on a surface, as such granulated radionucleides, as such particulates cause high dose rate exposure to a small area that is sufficient to cause such radiochromic dosimeters to change color. In addition, omitting the step of calibrating such radiochromic materials significantly reduces the cost of manufacturing the detector.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for detecting radioactive contamination in accordance with an exemplary embodiment of the present invention;

FIG. 2 is a diagram of a method for detecting radioactive contamination in accordance with an exemplary embodiment of the present invention; and

FIG. 3 is a diagram of exemplary embodiments of a radioactive contamination detector in accordance with teachings of the present invention.

### DETAILED DESCRIPTION OF PREFERRED EMBODIMENTS

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

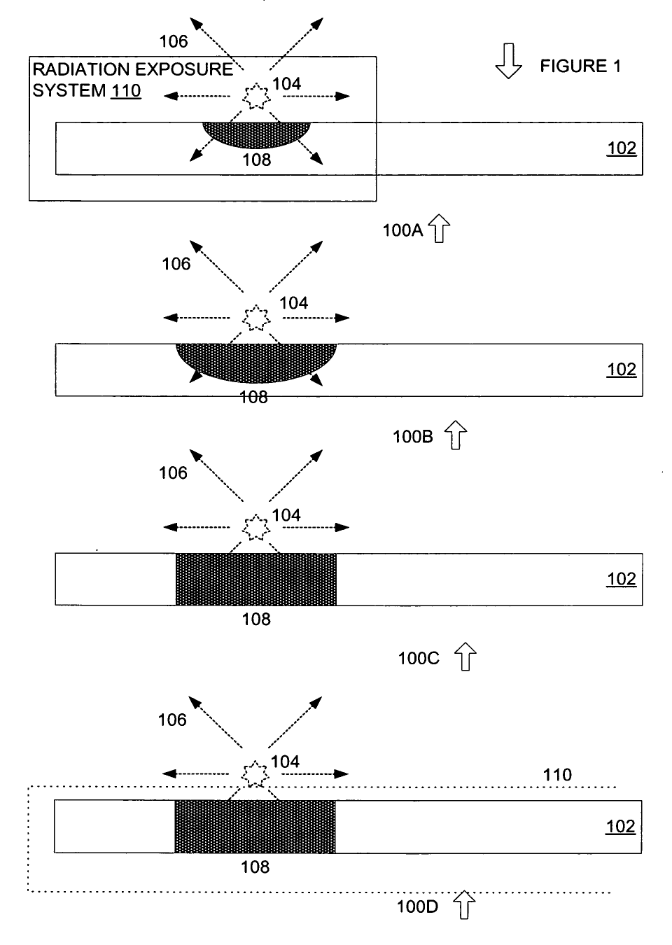

FIG. 1 is a diagram of systems 100A through 100C for detecting radioactive contamination in accordance with an exemplary embodiment of the present invention. System 100A uses radiochromic material 102 to determine whether a radioactive particle 104 that emits radiation 106 is present. Radiochromic material 102 is generally a clear material that undergoes a color change when the material is exposed to radiation 106. Radiation 106 can be alpha, beta, gamma, or other forms of radiation. Radiochromic material 102 is typically matched to the expected type of radiation that will be present, but can be a suitable radiochromic material when it is not known in advance what kind of radiation will be present. In this exemplary embodiment, radiochromic material 102 can be a selection of different radiochromic materials that are responsive to alpha, beta, and gamma radiation (including different materials in different places), can be a single material that is responsive to multiple types of radiation, a neutron bubble detector, or can be other suitable radiochromic or inexpensive high dose dosimeter materials. In addition, the radiochromic material does not need to be calibrated, as it is not necessary to determine whole body dose or other measures of radiation exposure in conjunction with the detection of radioactive contamination.

If radiochromic material 102 is exposed to a uniform radiation field, radiochromic material 102 will undergo a uniform color change, thus becoming more opaque and typically more opaque to radiation of a specific wavelength. If radiochromic material 102 is exposed to particulate radiation sources, though, spotting of the radiochromic material 102 can occur in the manner described herein.

The radioactive particles can include milled or ground particles of cobalt 60, cesium 137, or other elements that emit radiation as they break down into more stable elements, as well as salts or other compounds formed by such elements that are treated to be amenable to atmospheric dispersion. If such milled or ground particles or particulate compounds are released into the atmosphere, they will disperse and eventually settle on surfaces. Radiochromic material 102 is disposed on such surfaces in order to allow such contamination to be detected. If radiochromic material 102 includes different radiochromic materials that are responsive to different types of radiation, these different materials can be randomly or otherwise distributed on surfaces, in order to improve the chance of detecting particulate contamination of unknown origin or type. Likewise, radiochromic material 102 can be responsive to multiple types of radiation, or can be a composite of materials that are responsive to multiple types of radiation.

After radioactive particle 104 has been present for a period of time, radiochromic material 102 will begin to undergo a color change due to the exposure of color-changing materials in the radiochromic material to the energy of the radiation. The amount of radiation exposure will be a function of the specific reactivity of the source material of the particle, the mass of the particle, the degree to which the radioactive material of the particle has decayed, and the distance between the particle and the radiochromic material. Thus, after an initial period of time, a color change zone 108 shown in system 100A will exist. This color change zone may be noticeable to an unaided human observer as a dot on otherwise clear radiochromic material 102.

Likewise, as additional time passes, color change zone 108 will spread, as shown in system 100B and 100C. After sufficient time, color change zone 108 will spread to a quasi-steady state, where the amount of radiation that is reaching the unexposed radiochromic material 102 is too weak to cause the color to change in a manner that will cause color change zone 108 to spread by more than a small amount over a period of time.

System 100D include adhesive cover 110 for radiochromic material 102 that is used to secure radioactive particle 104 in the same location, so that periodic checks of radiochromic material 102 will not disrupt the exposure of radiochromic material 102 to radiation emitted by particle 102, thus allowing more frequent checks.

Radiation exposure system 110 can receive color change zone 108 data, radioactive particle 104 data, and other suitable data, and can determine the radiation dose that has been received by radiochromic material 102. In one exemplary embodiment, radiation exposure system 110 can include a sensitive radiation dose rate meter and can determine the received dose from the radiation dose rate and the size and depth of penetration of the color change zone 108 on radiochromic material 102. This determination of received dose is not dependent on the radiochromic material being calibrated, as the radiochromic material will have some known approximate dose response. However, to increase the accuracy of dose determination, calibrated radiochromic material can be used.

In operation, a user places radiochromic material 102 on surfaces that would be exposed to radioactive particulate contamination. For example, areas within enclosed spaces such as closets or desks would be less likely to receive deposited particulate contaminants from the atmosphere than areas on desks, countertops, on lawn furniture, on mail boxes, on parked automobiles, or on other suitable surfaces. In addition, no significant materials are placed on radiochromic material 102. In this regard, a significant material would be one that blocks a significant amount of radioactive material. Thus, for gamma radiation, thin layers of wood or other materials could be placed over radiochromic material 102, whereas for beta or gamma radiation, even layers of cardboard or paper could shield the radiochromic material from the radiation. If multiple types of radiochromic materials are used, then multiple types of protection can likewise be utilized. For example, gamma-sensitive materials might also be sensitive to ultraviolet light, such that. shielding of such materials with cardboard is desirable. Alternatively, alpha sensitive radiochromic materials might be less sensitive to ultraviolet light, allowing them to be displayed without significant layers of shielding that might also block alpha particles.

A user periodically inspects radiochromic material 102 to determine whether spotting has occurred, such as by holding radiochromic material 102 up to a light source and visually confirming whether spots have appeared on the radiochromic material. If no spots have appeared, and a statistically significant number of radiochromic materials 102 have been inspected, then the user can have some level of certainty that there is no particulate radioactive material present. Alternatively, if one or two spots are found, the user can request additional surveying with more sensitive equipment. If a large number of spots are found, the user should evacuate the premises and notify authorities. If uniform exposure is found, it should be determined whether an alternate source of radiation, such as ultraviolet light, has been used to illuminate the radiochromic material 102. If not, then additional inspection should be performed.

System 100A through 100C thus allow a user to perform an inexpensive go/no-go test to determine whether an area has been exposed to particulate radioactive contaminants. While additional examination of systems 100A through 100C can determine exposure time from the amount of spreading of color change zone 108, to the unaided observer systems 100a through 100C allow some indication of radioactive contamination to be provided, regardless of whether accumulated dose can not be readily determined. Systems 100A through 100C can thus be used to quickly determine whether an area has been exposed to particulate radioactive materials or is likely to be clear of such contamination, thus providing some peace of mind to users that may have concerns regarding the potential presence of radioactive contamination.

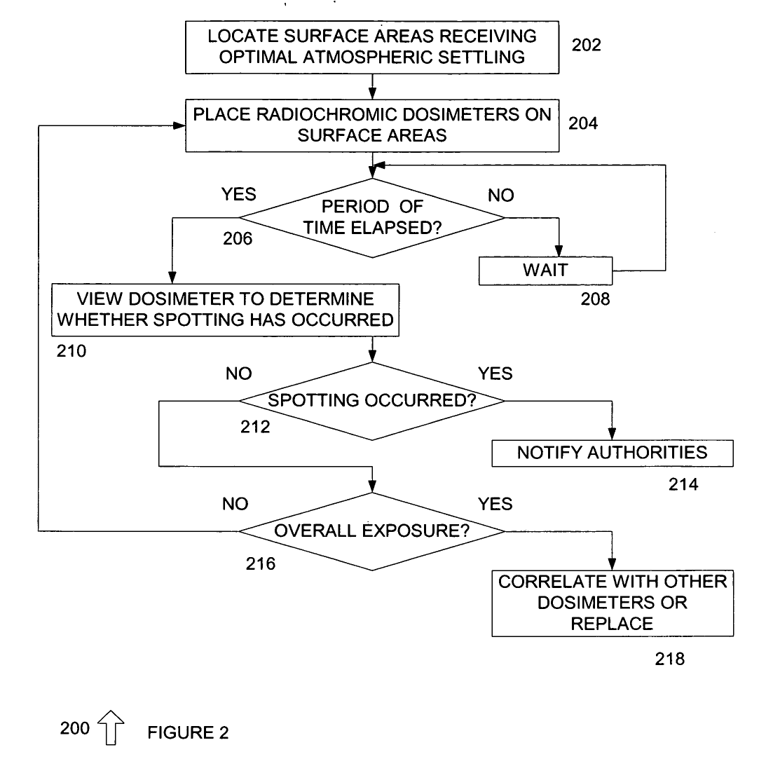

FIG. 2 is a diagram of a method 200 for detecting radioactive contamination in accordance with an exemplary embodiment of the present invention. Method 200 begins at 202 where areas are that are most likely to receive surface contaminant settling of atmospherically dispersed particulates. For example, enclosed spaces are less likely to receive particulate settling, as well as areas in which particulates may be blown or washed away by wind or rain. Areas without such problems are located at 200, and the method proceeds to 202.

At 202, radiochromic dosimeters are placed on the selected surfaces. In one exemplary embodiment, an assortment of radiochromic dosimeters can be used, such as those for detecting alpha, beta, or gamma radiation or other suitable types of radiation. Likewise, only a single type of radiochromic dosimeter can be used, such as for gamma or another radiation type of particular interest, a radiochromic dosimeter can be used that detects multiple types of radiation, a radiochromic dosimeter requiring protection from ultraviolet radiation can be used, or other suitable processes can be used. The radiochromic dosimeter can also be uncalibrated, such as to decrease the cost of manufacturing the radiochromic dosimeter where the radiochromic dosimeter is only going to be used to detect for the presence of radioactive contamination, or where the dose determination sensitivity does not require calibration. The method then proceeds to 206.

At 206 it is determined whether a predetermined period of time has elapsed. For example, if a radiochromic dosimeter is checked continuously, then any particulate contamination could be blown off or displaced and thus allow the contamination to go undetected. While an adhesive cover can be provided to minimize the potential detrimental affects from checking the dosimeter, it is nevertheless impractical to check the dosimeter continually. Thus, a period for checking should be determined, and the dosimeter should be allowed to potentially accumulate radioactive materials for a significant period of time prior to checking it again for exposure. The method then proceeds to 208 if it is determined that additional time is needed, otherwise, the method proceeds to 210.

At 210, the dosimeter is viewed to determine whether spotting has occurred. In one exemplary embodiment, the dosimeter is removed from a cover with an adhesive surface or is otherwise retrieved for viewing. Likewise, viewing with a device such as a color meter or other suitable equipment can be performed. The method then proceeds to 212.

At 212 it is determined whether spotting has occurred. In one exemplary embodiment, spotting can be detected using image analysis, human observers, or other suitable processes, such as by holding the radiochromic dosimeter up to a colored background that will cause spotting to b e highlighted. If spotting has occurred, the method proceeds to 214 and the authorities are notified. The authorities can then use more sensitive equipment to measure low dose rate, can evaluate the radiochromic material to determine estimated dose, or can perform or other suitable functions.

If no spotting is found the method proceeds to 216, where it is determined whether the overall exposure rate has been exceeded, such as may occur with UV radiation for certain types of radiochromic materials. If no overall exposure has occurred, the method returns to 204 for continued monitoring. If overall exposure is detected, the method proceeds to 218 and other dosimeters are checked, or it is otherwise determined whether it is necessary to receive more accurate assistance, replace dosimeters, or perform other suitable processes.

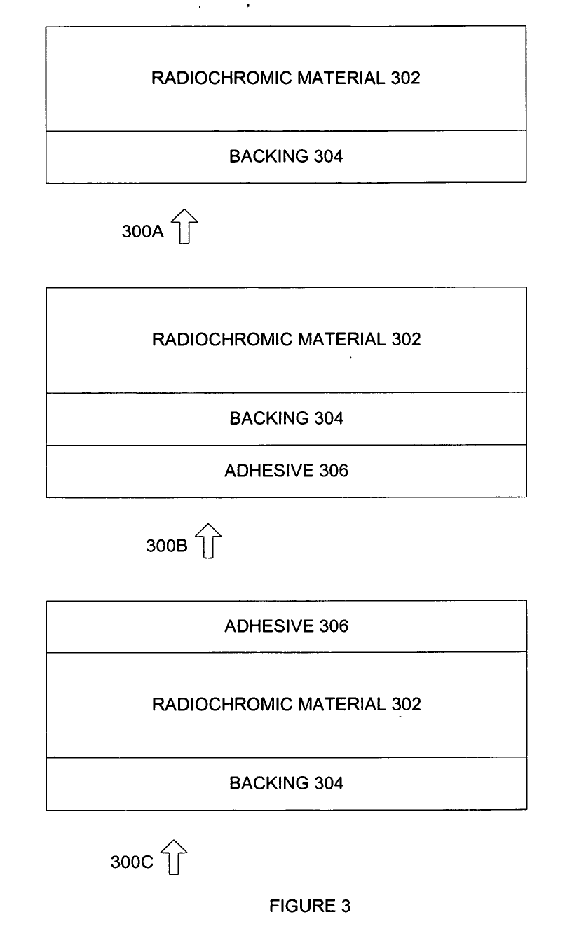

FIG. 3 is a diagram of exemplary embodiments 300A through 300C of a radioactive contamination detector in accordance with teachings of the present invention. These configurations are exemplary, and other configurations or materials may also or alternatively be used.

Radioactive contamination detector 300A includes a radiochromic material 302 and a backing 304. The backing can be an opaque backing, an adhesive backing, or other suitable types of backing that increase the material strength of the radiochromic material 302 or the resistance of the radiochromic material 302 to wear (such as mechanical wear, chemical wear, exposure to light, or other forms of wear). Radiochromic material 302 can also be uncalibrated, such as where the radiochromic material is made from material having a known color change behavior in response to a received dose of alpha, beta or gamma radiation, but where the accuracy of the dose response is not determined by testing that may otherwise be required to use the radiochromic material for dosimetry measurements that may be required by law, for medical treatment regimens, or in other circumstances where the accurate measurement of local or whole body dose may be important.

Radioactive contamination detector 300B includes a radiochromic material 302, a backing 304, and an adhesive 306. In this exemplary embodiment, the adhesive is disposed on the side of the backing 304 that is opposite from the radiochromic material 302, such as where the radiochromic material 302 may be too sensitive to light or atmospheric conditions such as moisture or dirt to allow the detector to be placed face up. In this exemplary embodiment, the detector is placed face down, and must be lifted periodically to determine whether radioactive contamination is present.

Radioactive contamination detector 300C includes a radiochromic material 302, a backing 304, and an adhesive 306. In this exemplary embodiment, the adhesive is disposed on the side of the radiochromic material 302 that is opposite from the backing 304, such as where the radiochromic material 302 does not need to be protected from light or atmospheric conditions. In this exemplary embodiment, the detector is placed face up, and can observed without being moved.

Although exemplary embodiments of a system and method for multiple image analysis have been described in detail herein, those skilled in the art will also recognize that various substitutions an modifications can be made to the systems and methods without departing from the scope and spirit of the appended claims.

What is claimed is

1. A system for detecting radiation comprising:
a surface that can accumulate particulate radioactive material; and
an uncalibrated radiochromic material disposed on the surface, such that radioactive material that accumulates on the radiochromic material will cause the uncalibrated radiochromic material to undergo a color change.

2. The system of claim 1 wherein the color change comprises spotting.

3. The system of claim 1 further an adhesive material disposed in a manner to hold the accumulated radioactive material.

4. The system of claim 1 further comprising a plurality of radiochromic materials, wherein two or more radiation types are detected using the plurality of radiochromic materials.

5. The system of claim 1 wherein the radiochromic material is a neutron bubble detector.

6. The system of claim 1 wherein a size of a spot of the radiochromic material increases with increasing exposure to the particulate radioactive material.

7. The system of claim 6 further comprising a radiation exposure system determining the exposure level based on the size of the spot.

8. The system of claim 1 further comprising a cover to prevent inadvertent exposure of the radiochromic material to ultraviolet radiation.

9. A method for detecting radioactive contamination comprising:
placing an uncalibrated radiochromic material on a surface;
determining whether spotting of the uncalibrated radiochromic material has occurred; and
determining that radioactive contamination is present from the spotting of the uncalibrated radiochromic material.

10. The method of claim 9 wherein placing the uncalibrated radiochromic material on the surface comprises placing the radiochromic material in a location where atmospherically dispersed particulates are likely to settle without being blown away or otherwise removed.

11. The method of claim 9 wherein placing the uncalibrated radiochromic material on the surface comprises placing a first radiochromic material that is responsive to a first radiation type on the surface and placing a second radiochromic material that is responsive to a second radiation type on the surface.

12. The method of claim 9 wherein placing the uncalibrated radiochromic material on the surface comprises placing a radiochromic material that is responsive to a first radiation type and a second radiation type on the surface.

13. The method of claim 9 wherein determining whether spotting of the radiochromic material has occurred comprises viewing the radiochromic material by a human observer.

14. The method of claim 9 wherein determining whether spotting of the radiochromic material has occurred comprises removing the radiochromic material from a protective sleeve.

15. The method of claim 9 wherein determining whether spotting of the radiochromic material has occurred comprises removing the radiochromic material from a protective sleeve with an external adhesive coating.

16. A radioactive contamination detector comprising:
a layer of uncalibrated radiochromic material;
a layer of material adhered to the uncalibrated radiochromic material; and
wherein the layer of material adhered to the radiochromic material improves the ability to determine by visual inspection when radioactive contamination is present.

17. The detector of claim 16 wherein the layer of material is an opaque material.

18. The detector of claim 16 wherein the layer of material is an adhesive material.

19. The detector of claim 16 wherein the layer of material is an opaque material, and further comprising an adhesive layer disposed on a surface of the detector.

20. The detector of claim 16 wherein the layer of material is an opaque material, and further comprising an adhesive layer disposed on a surface of the uncalibrated radiochromic material opposite from the layer of material.
